(19) United States
(12) Patent Application Publication
(10) Pub. No.: US 2026/0322871 A1
(43) Pub. Date: Oct. 15, 2026

(54) De-Centralized Edge-Based Task Offloading

(71) Applicant: Oracle International Corporation, Redwood Shores, CA (US)

(72) Inventor: Johnson Manuel-Devadoss, San Antonio, TX (US)

(73) Assignee: Oracle International Corporation, Redwood Shores, CA (US)

(21) Appl. No.: 19/175,590

(22) Filed: Apr. 10, 2025

(51) Int. Cl. H04L 67/1001

(52) U.S. Cl. CPC H04L 67/1001

(57) ABSTRACT

Techniques for distributed edge node task offloading management are disclosed. An edge server implementing an artificial intelligence (AI) model receives requests from devices to process tasks using the AI model. The edge server analyzes local edge server attributes, remote node attributes, and network attributes to determine whether to offload the task to another edge node. The edge node determines if it has sufficient processing capacity to perform the task in a specified timeframe. The edge node further determines if another edge node has sufficient processing capacity to perform the task. The edge node further determines whether to offload the task based on pending tasks on the other edge node, based on latency values associated with offloading the task, and based on energy consumption associated with offloading the task. If the edge node determines the offloading criteria are met, the edge node offloads the task to another edge node.

### TECHNICAL FIELD

The present disclosure relates to managing tasks in a network. In particular, the present disclosure relates to a de-centralized, edge-based, decision-making network for offloading tasks at edge nodes.

### BACKGROUND

User devices, including wearable devices, appliances, and handheld devices run applications requiring ever more processing power. Many processes are time-sensitive, such as telemetry prediction and control, virtual reality (VR), and augmented reality (AR) processes. However, due to size and cost constraints, user devices often have limited processing capabilities. Instead of processing time-sensitive, computationally intensive tasks on the user devices, systems offload the tasks to cloud devices that have greater computational resources. However, offloading tasks to remote cloud servers can introduce significant transmission delays. To mitigate this issue, edge computing has been developed and implemented to position servers closer to end users at the network edge, such as at base stations, to minimize transmission delays.

Many artificial intelligence (AI) models, especially deep learning models, are too large to be deployed directly on edge nodes, such as edge servers, base stations, and gateways, due to their high memory and computational requirements. This results in performance bottlenecks, as models can be slow or even unusable on servers with limited resources. Compared to cloud nodes, such as cloud servers, edge nodes have limited memory and storage capacity. This makes it difficult to deploy large, complex AI models that typically require significant memory space to store parameters (e.g., weights and activations in neural networks). These devices also have constrained computational resources, such as limited processing power and energy, which makes it difficult to perform complex AI tasks (like deep learning inference) locally in real time. Running large models or sending data to the cloud for computation consumes significant energy, which is a major concern for edge nodes that need to operate autonomously for long periods.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A-1C illustrate a system in accordance with one or more embodiments;

FIG. 2 illustrates an example set of operations for distributed task offloading in accordance with one or more embodiments;

FIGS. 3A and 3B illustrate example embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DE-CENTRALIZED EDGE NODE OFFLOADING ARCHITECTURE
3. DE-CENTRALIZED EDGE NODE TASK OFFLOADING
4. EXAMPLE EMBODIMENT
5. COMPUTER NETWORKS AND CLOUD NETWORKS
6. GENERATIVE AI MODELS
7. HARDWARE OVERVIEW
8. MISCELLANEOUS; EXTENSIONS

### 1. General Overview

One or more embodiments employ a de-centralized decision-making architecture to distribute resource-intensive tasks among network nodes. An edge node independently, or in communication with other edge nodes of a network, determines whether to execute a task or offload the task from the edge node to another device. The edge node may offload the task to another edge node or to a centralized component within the network.

In an example, an edge node includes a server at the edge of a network that operates as a processing node. The edge node receives communications from devices, referred to herein as “edge devices” that communicate with the edge nodes to perform computing tasks. Edge devices include Internet of Things (IoT) devices, such as appliances, wearable devices, and vehicles equipped with sensors and controllers that connect to a network via an edge node. In addition to edge devices, other devices, such as handheld devices, laptops, and desktop devices, may communicate with edge nodes to perform computing tasks. Edge nodes are managed by a central node such as a cloud server. For example, a user accessing a laptop may access cloud resources, including Software as a Service (Saas) applications, that are stored on a cloud server by sending requests through an edge server. Cloud providers optimize AI models to lower a memory footprint of the models, making it possible to implement the resource-intensive models on resource-constrained edge nodes. Implementing the AI models at the edge of the network rather than on internal network nodes reduces bottlenecks within the network. When an edge node receives a request that includes a task to be performed by an application running on the edge node, such as an AI model on the edge node, the edge node determines whether to execute the task or offload the task to another network node. The edge node makes the determination based on an analysis of its local computing resource attributes, attributes of remote network nodes, and network attributes, such as latency and bandwidth.

In one or more embodiments, an edge node maintains a record of properties of other edge nodes and tasks assigned to the other edge nodes. For example, any time an edge node receives a task from a central server or other edge node, a notification is sent to other edge nodes in the network. Upon receiving the request to execute a task, the edge node analyzes the stored record of its computing resource attributes and those of other network nodes. The edge node analyzes the record of the tasks assigned to the other network nodes. The edge node may consider additional task information, such as a priority level associated with a task and a complexity of the task.

In one or more embodiments, the edge node determines latency data associated with keeping or offloading the task and energy usage associated with keeping or offloading the task. The edge node may monitor network node attribute data, task data, and network data in real time. For example, as tasks are received by edge nodes in a network, the edge node may determine a candidate node for offloading a task has too heavy a workload, and the edge node may decide against offloading a task. Conversely, as the edge node receives notifications of completed tasks by other network nodes, the edge node may determine a candidate node for offloading could process a task in a specified timeframe, and the edge node may offload the task. As another example, as the edge node detects a high latency associated with a candidate node, the edge node may decide against offloading the task to the candidate node.

Based on real-time analysis of attributes of network nodes and network conditions, embodiments implement a de-centralized decision-making architecture to determine whether to offload resource-intensive tasks from one edge node to another in a network.

One or more embodiments described in this Specification and/or recited in the claims may not be included in this General Overview section.

### 2. De-Centralized Edge Node Offloading Architecture

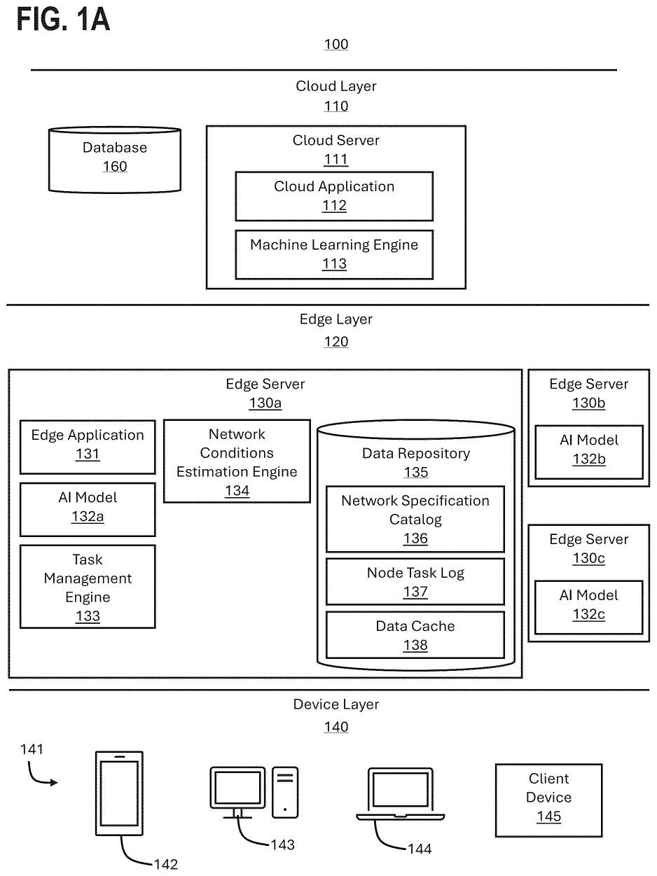

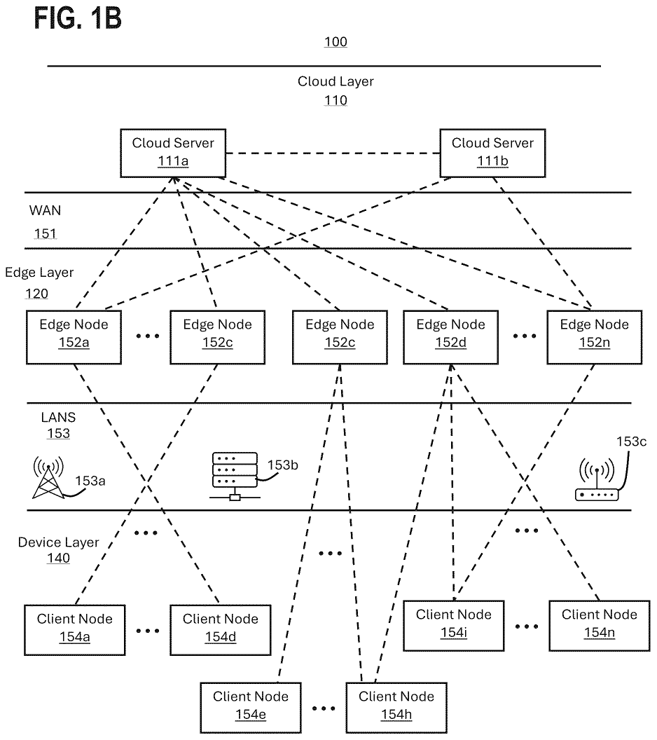

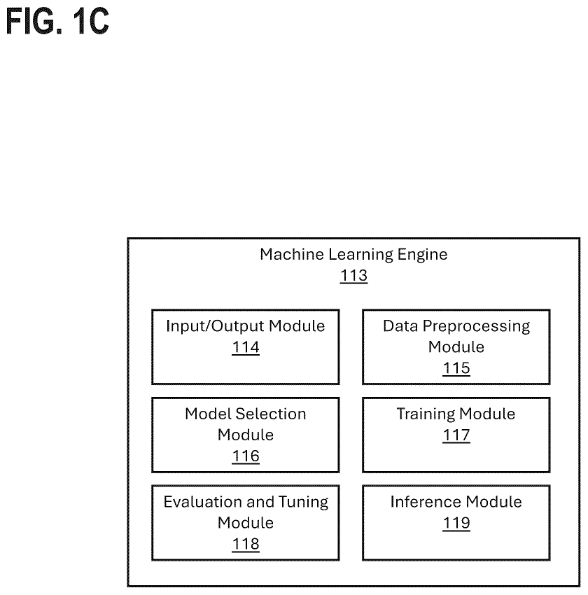

FIG. 1A illustrates a system 100 in accordance with one or more embodiments. As illustrated in FIG. 1A, system 100 includes a cloud layer 110, an edge layer 120, and a device layer 140. The cloud layer 110 includes one or more cloud servers 111. The cloud layer 110 may include one or more databases 160. The cloud server 111 may access data in the database 160 based on requests from devices in the edge layer 120 and/or in the device layer 130.

The edge layer 120 includes edger servers 130a, 130b, and 130c. The edge servers 130a-130c connect to the cloud server 111 via a wide area network (WAN) such as the Internet. In one or more embodiments, the WAN includes one or more servers and switches connected by data transmission media, such wireless transmitters, copper cables, and fiber optic cables. The edge layer 120 may include additional devices, such as gateways, routers, base stations, and servers.

The device layer 140 includes client devices 141. A client device 141 includes any device that connects with edger servers 130a-130c or the cloud server 111 to run cloud applications 112 running on the cloud server 111 and/or edge applications 131 running on the edge servers 130a-130c. Some examples of client devices 145 include IoT devices, such as sensors and controllers in vehicles, household appliances, consumer goods, toys, and wearable devices. Other devices that may connect with edge servers 130a-130c include mobile devices 142, such as mobile phones, desktop computer consoles 143, and laptop computers 144. Client devices 141 may communicate with the cloud server 111 via the WAN. Client devices 141 communicate with edge servers 130a-130c via a local area network (LAN). The LAN may include, for example, a wired or wireless router. In some embodiments, the LAN is implemented using other short-range communications protocols, such as BLUETOOTH and Radio Frequency Identification (RFID) technology.

FIG. 1B illustrates an example configuration of the system 100. As illustrated in FIG. 1B, a cloud layer 110 includes cloud servers 111a and 111b. While FIG. 1B illustrates two cloud servers, embodiments encompass any number of cloud servers. The cloud servers 111a and 111b in the cloud layer 110 are connected to edge nodes 152a-152n in the edge layer 120 via a WAN 151 such as the Internet. Edge nodes 152a-152n may correspond to edge servers, such as edge servers 130a-130c, and other edge devices, such as gateways and routers. As illustrated in FIG. 1B, a single cloud server 111a may be communicatively connected to multiple edge nodes 152a-152n. In addition, multiple cloud servers 111a and 111b may be communicatively connected to the same edge nodes 152a-152n. Edge nodes 152a-152n may further be communicatively connected to each other, such as by copper wire within a data center, by fiber optic cable, or via a network that includes transmission lines and routers and/or switches.

Edge nodes 152a-152n connect to client nodes 154a-154n via LANs 153. LANs 153 include base stations 153a, wired transmission lines and routers/switches 153b, and wireless routers 153c, for example. While FIG. 1B illustrates the base stations 153a, wired transmission lines and routers/switches 153b, and wireless routers 153c as separate from the edge nodes 152a-152n for purposes of illustrating data transmission modes, the edge nodes 152a-152n may be implemented within base stations 153a, wired transmission lines and routers/switches 153b, and wireless routers 153c. Client nodes 154a-154n include any computing devices capable of communicating with cloud servers 111a and 111b and/or edge nodes 152a-152n. As illustrated in FIG. 1B, a single edge node may connect to multiple client nodes 154a-154n. In addition, multiple edge nodes 152a-152n may connect to a single client node.

Referring to FIG. 1A, the cloud server 111 includes a machine learning engine 113 for training and re-training machine learning models, including the artificial intelligence (AI) models 132a, 132b, and 132c implemented on the edge servers 130a, 130b, and 130c. The AI models 132a-132c are implemented on the edge servers 130a-130c to provide client devices 141 with rapid access to complex computing without the need to transmit large amounts of data over the WAN to the cloud layer 110.

FIG. 1C illustrates an example of a machine learning engine 113 according to one or more embodiments. As illustrated in FIG. 1C, machine learning engine 113 includes input/output module 114, data preprocessing module 115, model selection module 116, training module 117, evaluation and tuning module 118, and inference module 119.

In accordance with an embodiment, input/output module 114 serves as the primary interface for data entering and exiting the system, managing the flow and integrity of data. This module may accommodate a wide range of data sources and formats to facilitate integration and communication within the machine learning architecture.

In an embodiment, an input handler within input/output module 114 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 114 to be versatile in different operational contexts, whether processing historical datasets or streaming data.

In accordance with an embodiment, input/output module 114 manages data integrity and quality as it enters the system by incorporating initial checks and validations. These checks and validations ensure that incoming data meet predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 114 includes an output framework designed to handle the distribution and exportation of outputs, predictions, or insights. Using the output framework, input/output module 114 formats these outputs into user-friendly and accessible formats, such as reports, visualizations, or data files compatible with other systems. Input/output module 114 also ensures secure and efficient transmission of these outputs to end-users or other systems in an embodiment and may employ encryption and secure data transfer protocols to maintain data confidentiality.

In accordance with an embodiment, data preprocessing module 115 transforms data into a format suitable for use by other modules in machine learning engine 113. For example, data preprocessing module 115 may transform raw data into a normalized or standardized format suitable for training ML models and for processing new data inputs for inference. In an embodiment, data preprocessing module 115 acts as a bridge between the raw data sources and the analytical capabilities of machine learning engine 113.

In an embodiment, data preprocessing module 115 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods, like imputation or removal of incomplete records, depending on the nature and volume of the missing data. Data preprocessing module 115 may be configured to handle anomalies in different ways, depending on context. Data preprocessing module 115 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 115 includes a feature encoding framework that ensures categorical variables are transformed into a format that can be easily interpreted by machine learning algorithms. Techniques, such as one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 115 processes new data for inference, data preprocessing module 115 replicates the same preprocessing steps to ensure consistency with the training data format. This helps to avoid discrepancies between the training data format and the inference data format, thereby reducing the likelihood of inaccurate or invalid model predictions.

In an embodiment, model selection module 116 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 116 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 116 utilizes techniques from the field of Automated Machine Learning (AutoML). AutoML systems automate the process of model selection by rapidly prototyping and evaluating multiple models. They use various techniques, like Bayesian optimization, genetic algorithms, or reinforcement learning, to explore the model space efficiently. Model selection module 116 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, for it represents a smaller average discrepancy between the actual and predicted values.

In accordance with an embodiment, model selection module 116 also considers computational efficiency and resource constraints. This is meant to help ensure the selected model is both accurate and practical in terms of computational and time requirements. In an embodiment, certain features of model selection module 116 are configurable such as a configured bias toward (or against) computational efficiency.

In accordance with an embodiment, training module 117 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 117 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 117 manages overfitting, where a model learns the training data too well, including its noise and outliers, at the expense of its ability to generalize to new data. Techniques, such as regularization, dropout (in neural networks), and early stopping, are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 117 includes logic to handle different types of data and learning tasks. For instance, it includes different training routines for supervised learning (where the training data comes with labels) and unsupervised learning (without labeled data). In the case of deep learning models, training module 117 also manages the complexities of training neural networks that include initializing network weights, choosing activation functions, and setting up neural network layers.

In an embodiment, evaluation and tuning module 118 incorporates dynamic feedback mechanisms and facilitates continuous model evolution to help ensure the system's relevance and accuracy as the data landscape changes. Evaluation and tuning module 118 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 118 performs continuous model tuning by using hyperparameter optimization. Evaluation and tuning module 118 performs an exploration of the hyperparameter space using algorithms, such as grid search, random search, or more sophisticated methods like Bayesian optimization. Evaluation and tuning module 118 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 118 integrates data feedback and updates the model. Evaluation and tuning module 118 actively collects feedback from the model's real-world applications, an indicator of the model's performance in practical scenarios. Such feedback can come from various sources, depending on the nature of the application. For example, in a user-centric application, such as a recommendation system, feedback might comprise user interactions, preferences, and responses. In other contexts, like predicting events, it might involve analyzing the model's prediction errors, misclassifications, or other performance metrics in live environments.

In an embodiment, feedback integration logic within evaluation and tuning module 118 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 118 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 119 transforms raw data into actionable, precise, and contextually relevant predictions. In addition to processing and applying a trained model to new data, inference module 119 may also include post-processing logic that refines the raw outputs of the model into meaningful insights.

In an embodiment, inference module 119 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 119 transforms the outputs of a trained model into definitive classifications. Inference module 119 employs the underlying model as a tool to generate probabilistic outputs for each potential class. It then engages in an interpretative process to convert these probabilities into concrete class labels.

In an embodiment, when inference module 119 receives the probabilistic outputs from the model, it analyzes these probabilities to determine how they are distributed across some, or every, potential class. If the highest probability is not significantly greater than the others, inference module 119 may determine that there is ambiguity or interpret this as a lack of confidence displayed by the model.

In an embodiment, inference module 119 uses thresholding techniques for applications where making a definitive decision based on the highest probability might not suffice due to the critical nature of the decision. In such cases, inference module 119 assesses if the highest probability surpasses a certain confidence threshold that is predetermined based on the specific requirements of the application. If the probabilities do not meet this threshold, inference module 119 may flag the result as uncertain or defer the decision to a human expert. Inference module 119 dynamically adjusts the decision thresholds based on the sensitivity and specificity requirements of the application subject to calibration for balancing the trade-offs between false positives and false negatives.

In accordance with an embodiment, inference module 119 contextualizes the probability distribution against the backdrop of the specific application. This involves a comparative analysis, especially in instances where multiple classes have similar probability scores, to deduce the most plausible classification. In an embodiment, inference module 119 may incorporate additional decision-making rules or contextual information to guide this analysis, ensuring that the classification aligns with the practical and contextual nuances of the application.

In regression models, where the outputs are continuous values, inference module 119 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 119 incorporates domain-specific adjustments into its post-processing routine. This involves tailoring the model's output to align with specific industry knowledge or contextual information. For example, in financial forecasting, inference module 119 may adjust predictions based on current market trends, economic indicators, or recent significant events, ensuring that the outputs are both statistically accurate and practically relevant.

In an embodiment, inference module 119 includes logic to handle uncertainty and ambiguity in the model's predictions. In cases where inference module 119 outputs a measure of uncertainty, such as in Bayesian inference models, inference module 119 interprets these uncertainty measures by converting probabilistic distributions or confidence intervals into a format that can be easily understood and acted upon. This provides users with both a prediction and an insight into the confidence level of that prediction. In an embodiment, inference module 119 includes mechanisms for involving human oversight or integrating the instance into a feedback loop for subsequent analysis and model refinement.

In an embodiment, inference module 119 formats the final predictions for end-user consumption. Predictions are converted into visualizations, user-friendly reports, or interactive interfaces. In some systems, like recommendation engines, inference module 119 also integrates feedback mechanisms, where user responses to the predictions are used to continually refine and improve the model, creating a dynamic, self-improving system.

In an embodiment, input/output module 114 receives a dataset intended for training. This data can originate from diverse sources, like databases or real-time data streams, and in varied formats, such as CSV, JSON, or XML. Input/output module 114 assesses and validates the data, ensuring its integrity by checking for consistency, data ranges, and types.

In an embodiment, training data is passed to data preprocessing module 115. Here, the data undergoes a series of transformations to standardize and clean it, making it suitable for training ML models. This involves normalizing numerical data, encoding categorical variables, and handling missing values through techniques like imputation.

In an embodiment, prepared data from the data preprocessing module 115 is then fed into model selection module 116. This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 117 trains the selected model with the prepared dataset. It implements learning algorithms to adjust the model's internal parameters, optimizing them to identify patterns and relationships in the training data. Training module 117 also addresses the challenge of overfitting by implementing techniques, like regularization and early stopping, ensuring the model's generalizability.

According to an example embodiment, AI models 132a-132c include neural networks. For example, the AI models 132a-132c may be implemented as deep-learning neural networks. The training module 117 applies a machine learning algorithm to a training data set to train AI models 132a-132c. For example, the machine learning algorithm may analyze the training data set to train neurons of a neural network with particular weights and offsets to associate particular sets of task attributes, node attributes, and network attributes with particular offload decisions.

In some embodiments, the training module 117 iteratively applies the machine learning algorithm to a set of input data to generate an output set of labels, compares the generate labels to pre-generated labels associated with the input data, adjusts weights and offsets of the algorithm based on an error, and applies the algorithm to another set of input data. In some cases, the training module 117 may generate and train a candidate recurrent neural network model such as a long short-term memory (LSTM) model. With recurrent neural networks, one or more network nodes or “cells” may include a memory. A memory allows individual nodes in the neural network to capture dependencies based on the order in which feature vectors are fed through the model. The weights applied to a feature vector representing one feature may depend on its position within a sequence of feature vector representations. Thus, the nodes may have a memory to remember relevant temporal dependencies between different sets of input features.

In some embodiments, the training module 117 compares the labels estimated through the one or more iterations of the machine learning model algorithm with observed labels to determine an estimation error. The training module 117 may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the training module 117 determines whether to adjust the weights and/or other model parameters based on the estimation error. Adjustments may be made until a candidate model that minimizes the estimation error or otherwise achieves a threshold level of estimation error is identified. In some embodiments, the training module 117 selects machine learning model parameters based on the estimation error meeting a threshold accuracy level. For example, the system may select a set of parameter values for a machine learning model based on determining that the trained model has an accuracy level for predicting labels of at least 98%.

In an embodiment, evaluation and tuning module 118 evaluates the trained model's performance using the validation dataset. Evaluation and tuning module 118 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 114 receives a dataset intended for inference. Input/output module 114 assesses and validates the data.

In an embodiment, data preprocessing module 115 receives the validated dataset intended for inference. Data preprocessing module 115 ensures that the data format used in training is replicated for the new inference data, maintaining consistency and accuracy for the model's predictions.

In an embodiment, inference module 119 processes the new data set intended for inference, using the trained and tuned model. It applies the model to this data, generating raw probabilistic outputs for predictions. Inference module 119 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

Referring to FIG. 1A, the edge server 130a includes one or more edge applications 131 and an AI model 132a. The edge applications 131 and AI model 132a are accessible by the devices 141 for performing operations on the devices 141. For example, device 142 may request the AI model 132a perform a particular task to generate a prediction, classify data, such as documents or images, identify anomalies, etc. A task management engine 133 manages tasks directed to the edge server 130a. The task management engine 133 may determine whether to perform tasks at the edge server 130a or offload tasks to another edge server 130b or 130c or to the cloud server 111.

In one or more embodiments, the AI models 132a-132c are quantized and optimized to allow the system to run the AI models 132a-132c on the resource-constrained edge nodes 130a-130c. Quantization is a technique used to reduce the computational complexity and memory footprint of the AI models 132a-132c by converting high-precision numerical values, such as 32-bit floating point, into lower-precision formats, such as 16-bit floating point, 8- bit integers, or even lower. This process enables the AI models 132a-132c to run efficiently on the resource-constrained edge nodes 130a-130c.

In one or more embodiments, the AI models are optimized by pruning the models 130a-130c to remove unnecessary parameters (such as weights and neurons) to reduce their size and computational requirements without significantly affecting performance. This process helps improve inference speed, reduce memory usage, and enable deployment on resource-constrained edge nodes 130a-130c. According to one example, the machine learning engine 113 of the cloud server 111 optimizes the models 132a-132c. The machine learning engine 113 may perform weight pruning by eliminating individual weights in a neural network by setting them to zero, reducing model complexity while maintaining the same architecture. Additionally, or alternatively, the machine learning engine 113 may perform neuron pruning by removing entire neurons (along with their associated connections) that contribute little to the model's output, reducing both computational and storage costs. In some embodiments, the machine learning engine may perform structured pruning by removing entire filters, channels, or layers, leading to a structured reduction in the model's architecture and making it easier to accelerate inference. Additionally, or alternatively, the machine learning engine 113 may perform unstructured pruning by randomly removing weights based on their importance, leading to sparse weight matrices that require specialized hardware for efficient execution.

In one or more embodiments, the machine learning engine 113 performs iterative pruning by gradually removing parameters over multiple training cycles, allowing the model to adapt and regain accuracy after each pruning step.

According to an example, the machine learning engine 113 fully trains the AI model 132a. The machine learning engine 113 applies a magnitude-based pruning technique to identify small-weight connections among neurons in the model. The machine learning engine 113 prunes parameters of the model by setting the identified weights with small-weight connections to zero or by removing corresponding neurons from the model. The machine learning engine 113 may subsequently retrain the model on the original dataset to recover any lost accuracy.

A network conditions estimation engine 134 generates estimates of network conditions to provide to the task management engine 133. The network conditions estimation engine 134 analyzes network data to estimate real-time network conditions. For example, the network conditions estimation engine 134 may analyze a Round Trip Time (RTT), packet loss, or Time to First Byte (TTFB) to estimate latency between nodes in a network. As another example, the network conditions estimation engine 134 may estimate an energy consumption associated with executing a task. The estimate may include (a) an estimate for the edge server 130a to perform the assigned task and (b) an estimate for the edge server 130a to offload the task to another edge server such as edge server 130b. The estimate of energy consumption to offload the task may include (i) an estimate of energy required to transmit the data necessary to perform the task, (ii) an estimate of energy required by the edge server 130b to perform the task, and (iii) an estimate of energy required by edge server 130b to transmit results to a target. For example, if the request to perform the task is received from a cell phone 142, the network conditions estimation engine 134 estimates (a) the energy required for the edge server 130a to perform the task and transmit the results via a base station to the cell phone 142 and (b) the energy required for the edge server 130b to perform the task and transmit the results via a base station to the cell phone 142. For example, the edge server 130b may have more computing resources available to perform a task, but the edge server 130b may require more hops to transmit the results to the cell phone 142 than if the edge server 130a transmits results to the cell phone 142. The additional hops may include transmitting results via a fiber optic cable to a first base station, then to a second base station, then to the cell phone 142. In contrast, the edge server 130a may require only transmission of results to a base station to then transmit the results to the cell phone 142. In other words, the network conditions estimation engine 134 may estimate that it would require less energy for the edge server 130a to perform the task than for the edge server 130a to offload the task to the edge server 130b. The task management engine 133 determines if the offload tasks assigned to the edge server 130a should be offloaded to other nodes in the network based at least on estimated network conditions, such as latency and energy consumption.

The task management engine 133 makes offloading determinations based on a variety of factors, including the following: network conditions, such as bandwidth between edge nodes; bandwidth between the edge server 130a and the cloud server 111; latency between edge servers 130a-130c and between the edge server 130a and the cloud server 111; a complexity of a task; processing resources of the edge server 130a and offloading candidates; the workload of the edge server 130a and offloading candidates; an urgency of a task; and energy consumption to perform the task by the edge server 130a or by offloading candidates. In one or more embodiments, the task management engine 133 may determine a security requirement associated with a task and security specifications of network nodes such as edge servers 130a-130c. In addition, the task management engine 133 may implement security policies associated with offloading tasks, such as prohibiting offloading of tasks with particular security designations, limiting task offloading to network nodes located in particular geographic locations, and/or network nodes located a particular number of hops away from the edge server 130a.

A data repository 135 stores a network specification catalog 136. The network specification catalog 136 includes specification of edge servers 130a-130c and cloud server 111. The task management engine 133 refers to the network specification catalog 136 to determine features of additional servers and/or nodes in a network, such as processing resources, memory resources, and maximum bandwidth values. A node task log 137 includes a record of tasks assigned to nodes in the network. The node task log 137 may store task attributes, such as a size of a task, a priority level of a task, and resources required to complete the task. In one example, the node task log 137 is an edge server task log that stores tasks assigned to edge servers 130a-130c. For example, if the cloud server 111 assigns a task to edge server 130b, the edge server 130a stores task attributes, such as type and size, in the node task log 137. The edge servers 130b and 130c may also store the task attributes in task logs maintained by the respective edge servers 130b and 130c. In some embodiments, the node task log 137 includes tasks assigned to cloud server 111. As nodes complete tasks, the edger server 130a updates the node task log 137. The edge server 130a may update task data to indicate the task is complete. Additionally, or alternatively, the node task log 137 may be a record of pending tasks. Accordingly, the edge server 130a may remove tasks from the log based on receiving notifications of the task completions.

The task management engine 133 refers to the network specification catalog 136 and the node task log 137 to make offloading decisions. For example, when determining whether or not to offload a received task to edge server 130b, the task management engine 133 identifies the processing resources available to edge server 130b from the network specification catalog 136. The task management engine 133 further identifies the tasks assigned to the edge server 130b from the node task log 137. Based on tasks assigned to nodes in the network, task attributes of the tasks, network attributes, and node attributes, the task management engine 133 of the edge server 130a makes decisions whether to perform tasks assigned to the server 130a or to offload the tasks to other nodes, such as edge servers 130b or 130c in the network. Accordingly, the system 100 employs a distributed offloading decision-making process where distributed edge nodes, such as edge servers 130a-130c, make decisions independently whether to perform assigned tasks or offload the assigned tasks to other nodes including other edge nodes.

A data cache 138 includes locally stored data in the edge server 130a for executing operations on the edge application 131 and/or the AI model 132a. The data cache 138 may store variables, records, instructions, interim calculation results, completed calculation results, vectors, embeddings, and any other type of data provided to, used by, and/or generated by the edge application 131 and the AI model 132a.

In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks.”

In one or more embodiments, a data repository 135 is any type of storage unit and/or device (e.g., a file system, database, collection of tables, or any other storage mechanism) for storing data. Furthermore, a data repository 135 may include multiple different storage units and/or devices. The multiple different storage units and/or devices may or may not be of the same type or located at the same physical site. Furthermore, a data repository 135 may be implemented or executed on the same computing system as the edge server 130a. Additionally, or alternatively, a data repository 135 may be implemented or executed on a computing system separate from the edge server 130a. The data repository 135 may be communicatively coupled to the edge server 130a via a direct connection or via a network.

Information describing a network specification catalog 136, a node task log 137, and a data cache 138 may be implemented across any of components within the system 100. However, this information is illustrated within the data repository 135 for purposes of clarity and explanation.

In an embodiment, cloud servers 111 and edge servers 130a-130c are implemented on one or more digital devices. The term “digital device” generally refers to any hardware device that includes a processor. A digital device may refer to a physical device executing an application or a virtual machine. Examples of digital devices include servers, hardware routers, hardware switches, base stations, and other communication management devices.

### 3. De-Centralized Edge Node Task Offloading

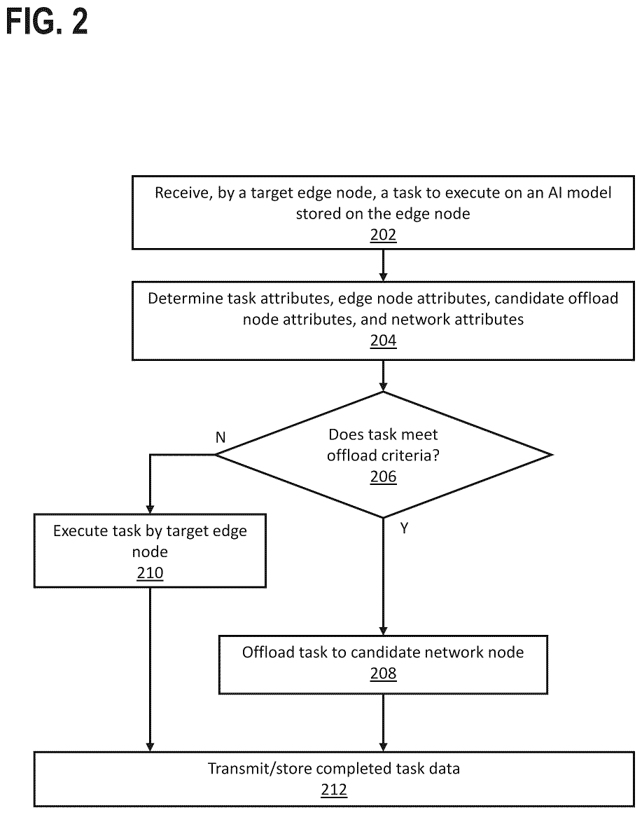

FIG. 2 illustrates an example set of operations for de-centralized edge node task offloading in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, a target edge node receives a task to execute on an AI model stored on the target edge node (Operation 202). The task may be received from a cloud device or a client device. An example of a cloud device is a central cloud server. A central cloud server may connect to multiple edge devices via a WAN such as the Internet. The central cloud server may receive and execute tasks and distribute tasks to edge nodes such as edge servers. Cloud devices, including cloud servers, are referred to herein as cloud nodes. Cloud nodes are characterized by substantial computing resources, including server clusters, large numbers of processors and processing cores, and large quantities of available memory. In particular, cloud nodes typically have more processing and memory capacity than edge nodes. In addition, edge nodes typically have more processing and memory capacity than client devices.

Client devices include any computing device that connects to network nodes, such as edge nodes and cloud nodes. The client devices may generate requests to network nodes to perform operations on applications and machine learning models stored on the network nodes. Examples of client devices include cellular phones, other mobile phones and communication devices, laptop computers, tablet computers, desktop computers, consumer devices, such as wearable devices, electronics devices, appliances, and vehicles, such as automobiles, watercraft, and aircraft.

In one or more embodiments, devices communicate with edge servers using standard networking protocols to transmit data associated with the request. Examples of network protocols include Transmission Control Protocol/Internet Protocol (TCP/IP) and User Datagram Protocol (UDP).

The system determines task attributes, edge node attributes, candidate offload node attributes, and network attributes (Operation 204). Task attributes include a size of the task, such as a number of operations associated with the task, and an amount of data associated with the task (e.g., bytes, Mbytes, Gbytes, or Terabytes). Task attributes further include a priority associated with the task. Task priority may be determined by an agent or application that generates the task. Task priority may be determined based on a source of a task. The source of the task may include a source device, a user associated with the task, or an application type associated with the task. For example, a particular computing device may be assigned a high priority by a system corresponding to system-critical tasks that are generated by the computing device. Another computing device may be assigned a lower priority based on being associated with a particular user or non-critical tasks.

Task attributes may further include security attributes associated with a task. Security attributes may specify particular devices or types of devices that may be used to execute a task. Security attributes may specify a number of hops a system may allow a task to pass through prior to execution on a device. Security attributes may specify a security level of a user, device, and/or application associated with a task.

Task attributes include a type, size, and complexity of a task. For example, a request to perform an AI task may include a set of input data, such as images, documents, telemetry data, time-series data, and other data, to be provided to an AI model to generate one or more predictions, classifications, answers, or other AI-generated content. Task complexity may include types of calculations and/or inferences. Some tasks may be implemented with relatively simple applications and/or models, such as a classification-type machine learning model or a deep-forest type model. Other tasks may be implemented by a more complex model such as a transformer-type model.

Edge node attributes and candidate offload node attributes include computing resources available in the target edge node and in one or more additional network nodes. Computing resources include a number of processors, types of processors, a processing capacity, a number of pending tasks, priority levels of pending tasks, an amount of data storage capacity, types of data storage (e.g., cache, random-access, read-only), and a type of edge node (e.g., graphics processing unit (GPU) server or central processing unit (CPU) server).

Network attributes include data transmission characteristics, such as latency between network nodes (e.g., between edge servers, or between an edge server and a cloud server), latency between edge nodes and edge devices, estimated available bandwidth, and estimated power usage to perform or offload a task.

Based on the task attributes, the edge nodes attributes, the candidate offload node attributes, and the network attributes, the system determines if a task meets offload criteria (Operation 206). The target edge node determines if it has sufficient local computing resources to process the task. For example, the target edge node determines if it has sufficient processing capacity, memory, and power capacity to process the task within a defined timeframe. The defined timeframe may be based on a system specification, such as 20 seconds, 1 minute, or 5 minutes.

If the target edge node has sufficient capacity to process the task within the defined timeframe and within a certain power usage threshold, the target edge node determines the task does not meet offload criteria. The target edge node may execute the task (Operation 210). The edge node may provide a set of input data associated with the task to the AI model stored in the edge node. For example, the edge node may convert a set of input data into an input vector, provide the input vector to the AI model, and generate a set of output data based on the input vector.

If the target edge node lacks sufficient capacity to process the task within the defined timeframe, the target edge node determines if another network node has sufficient capacity to process the task within the defined timeframe and within the power usage threshold. The target edge node may select candidate network nodes for analysis based on various criteria, such as a geographic location of the candidate network node, a geographic distance from the target edge node to the candidate network node, or a distance along the network from the target edge node to the candidate network node (e.g., a number of hops, switches, and/or servers between the nodes). The target edge node determines if a candidate network node has sufficient processing capacity, memory, and power capacity to process the task within a defined timeframe.

Target edge nodes may store task data associated with other edge nodes, edge devices, and cloud devices. When one network node in a network receives a request to perform a task, a notification including task attributes may be transmitted to other network nodes. The edge nodes store a log of tasks assigned to other network nodes. The edge nodes update the logs based on receiving notifications of completed tasks by the other network nodes. The target edge node analyzes the task log to determine if candidate network nodes have sufficient processing capacity to execute the task within the defined timeframe. For example, the target edge node may determine that a candidate edge node has a sufficient processing capacity. The target edge node may further determine that the candidate edge node assigned to complete one or more tasks that are a higher priority than a target task under consideration for offloading. The candidate network edge node's task queue may result in the target edge node determining that the candidate edge node is an unacceptable candidate for offloading the target task.

As another example, a target edge node may determine that a candidate edge node has sufficient processing capacity to execute a target task. The target edge node may further determine that the candidate edge node's task queue would allow the candidate edge node to execute the target task within the defined timeframe. Accordingly, the target edge node may determine that the candidate edge node meets the offloading criteria.

According to yet another example, a target edge node may determine that the candidate edge node has sufficient processing capacity to execute a target task. However, the target edge node may determine that network conditions, such as a latency in transmitting task data from the target edge node to the candidate edge node, may exceed a threshold. Accordingly, the target edge node may determine that the candidate edge node fails to meet the offloading criteria.

In one or more embodiments, the offloading criteria include energy costs. A target edge node may weigh the energy cost of executing the task on the target node with the energy cost to transmit the task data to a candidate network node.

In one or more embodiments, the offloading criteria include a type of AI model. For example, the target edge node may determine that the received request to execute the task specifies a type of AI model. The target edge node may select candidate network nodes based on determining the candidate network nodes store AI models of the type required to perform the task.

If the target edge node determines offload criteria are met, the target edge node offloads the task to a candidate network node (Operation 208). Offloading the task may include transmitting task data, such as input data to be provided to an AI model and instructions for applying the input data, to the candidate network node. The selected candidate network node may be an edge node such as an edge server. Alternatively, the selected candidate network node may be a cloud node such as a cloud server.

Upon completing the task, the selected candidate network node stores and/or transmits the data output from the AI model (Operation 212). In one example, a selected candidate network node transmits a reply to a requesting device. The reply includes output data generated by the AI model stored on the candidate network node. In another example, a selected candidate network node transmits a reply to the target edge node. The target edge node may then transmit a reply to the requesting device. The reply includes the output data generated by the AI model stored on the candidate network node.

In one or more embodiments, edge nodes running resource-intensive applications, such as AI models, are configured to make autonomous decisions—without receiving instructions from a central server—whether to perform received tasks or offload the received tasks to other network nodes. Autonomous, de-centralized, task-offloading decision-making is made possible by configuring a system to provide edge nodes with task data and computing resource specifications of other network nodes. The autonomous, de-centralized, task-offloading decision-making is further made possible by providing the edge nodes with computing modules—including software applications running on processors—to analyze network conditions such as latency values associated with offloading tasks.

In one or more embodiments, edge nodes in a network monitor tasks, capacity, and network conditions in real time to determine whether or not to offload tasks from edge nodes to other network nodes, including other edge nodes and cloud nodes. Based on changing conditions, edge nodes may offload pending or queued tasks to other network nodes. For example, instead of receiving a particular request to perform a task, as described in Operation 202, a target edge node may determine that, based on changed network conditions, a queued task assigned to the target edge node may be offloaded to another edge node. Edge nodes may receive tasks from client devices, such as user devices, IoT devices, and vehicles. Edge nodes may also receive tasks from cloud nodes, such as cloud servers, as well as from other edge nodes.

In one or more embodiments, edge nodes analyze candidate network nodes for offloading tasks based on a network's hierarchal structure. For example, a network may be configured to connect a first set of edge nodes to a first set of central servers and a second set of edge nodes to a second set of central servers. A target edge node in the first set of edge nodes may receive a request to execute a task with an AI model stored in the target edge node. The target edge node may first analyze the first set of edge nodes to determine whether or not to offload the task. If the first edge node determines the first set of edge nodes is inadequate for offloading the task, the first edge node may analyze the second set of edge nodes to determine whether or not to offload the task to an edge node among the second set of edge nodes.

In one or more embodiments, an edge node determines that a task may be divided into independently executable sub-tasks. For example, a task may specify three separate operations for applying AI models to a set of image data and a fourth operation for applying the results of the three operations to an AI model. The edge node may offload one or more sub-tasks to other edge nodes based on the criteria described above. For example, the original edge node may determine, based on task priority attributes, local and remote processing capacity attributes, and estimated latency values, that two remote edge nodes may be used to process two sub-tasks. The original edge node offloads the sub-tasks to the remote edge nodes and keeps a sub-task to process itself by an AI model on the original edge node. The remote edge nodes may transmit results to the original edge node. The original edge node may aggregate the results from the three sub-tasks and apply the AI model to the aggregated results. The original edge node transmits the results to a requesting device.

### 4. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

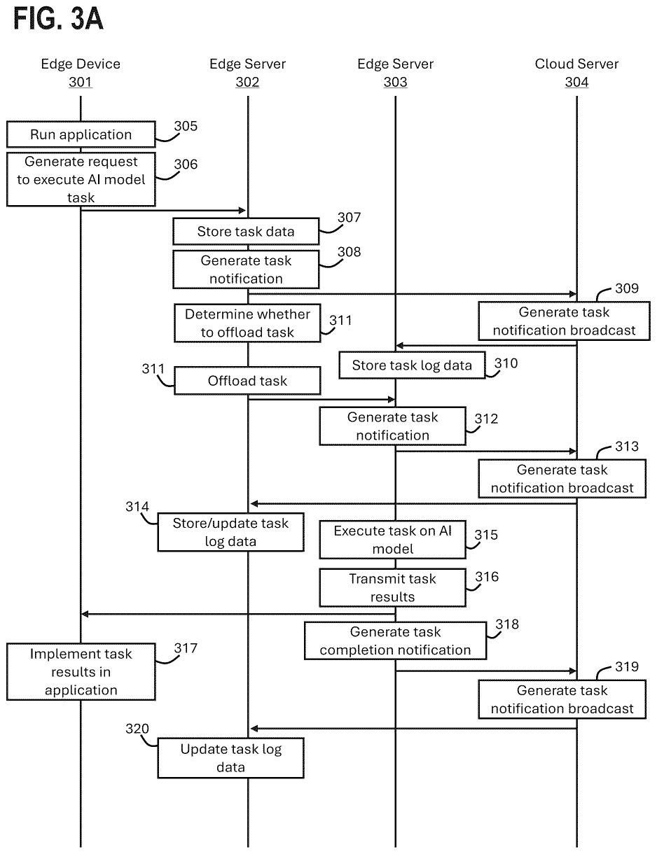

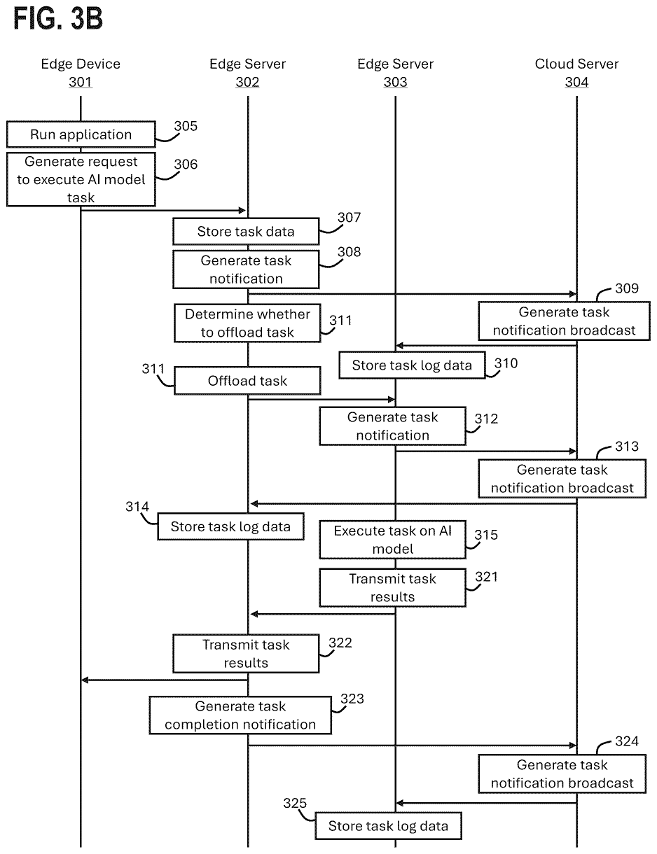

Referring to FIG. 3A, a user runs an application (Operation 305) on an edge device 301, such as on a wearable device worn by a user. The application utilizes an AI model to perform operations of the application. For example, the application may use an AI model to generate and/or modify images. The AI model may be a deep learning model for generating written and/or visual content, for extracting semantic meaning from text and/or images, or for performing anomaly predictions.

According to one example embodiment, the application is a voice-activated virtual assistant that employs natural language processing (NLP) to understand and respond to voice commands. The application may use an AI model to determine words spoken by users. According to another example, the application is a photography application. The application may employ an AI model to analyze an image detected by photosensors to automatically adjust camera settings for optimal image quality. According to another example, the application employs an AI model to perform facial recognition. The AI model may perform facial recognition to allow access to the application or functions in the application or for tagging photos. According to yet another example, the application applies the AI model to generate Augmented Reality (AR) effects. For example, the edge device 301 may be a wearable headset. A user may look into the headset to see an environment around the user. The AI model may generate images that are overlaid over the environment the user sees in real time. In some applications, the AR elements may interact with elements in the user's observed environment.

According to another example embodiment, the application uses the AI model to automatically modify digital images. The application may be an imaging editing feature. The application may provide image data to the AI model. The AI model may generate image modification data to modify the image. In another example, the application applies an AI model to perform one or both of natural language processing and semantic analysis. The application may apply an AI model to understand a user's spoken words and to generate a written or audio output that translates the user's spoken words into another language. In another example, the application applies a deep learning AI model to predict recommendations, operations, and application functions to personalize a user's interaction with the application. Examples of applications that utilize AI models to personalize a user's experience include language-learning applications, productivity applications, and health and fitness applications.

The edge device 301 generates a request to execute the AI model task (Operation 306). The edge device 301 sends the request to the edge server 302. The edge device 301 is connected to the edge server 302 via a LAN. The LAN may include a wireless network. For example, the edge device 301 may transmit the request including the AI model task to the edge server 302 via a wireless router using a TCP/IP protocol.

The edge server 302 stores task data (Operation 307). Task data includes data describing a type of AI model associated with the request, input data to provide to the AI model to perform the task or a description of a location on the device where the input data could be retrieved by the edge server 102, and information on a type of output data requested. The task data includes a data size of input/output data associated with the request and a description of a data type of input/output data associated with the request.

The edge server 302 generates a task notification and transmits the task notification to the cloud server 304 (Operation 308). The task notification includes a task description, including a type of task, a task identifier, and a size of the task.

The cloud server 304 generates a task notification broadcast (Operation 309). The broadcast provides the data included in the task notification received from the edge server 302. The cloud server 304 transmits the task notification broadcast to edge servers in the same network as the cloud server 304, including the edge server 303. The edge servers, including the edge server 303, store task log data (Operation 310). Based on receiving the notification broadcasts, the edge servers in the same network as the cloud server 304 store task logs for (a) their own assigned tasks and (b) tasks assigned to other edge servers in the network.

The edge server 302 determines whether or not to offload the task to another server, including the edge server 303 and the cloud server 304 (Operation 311). The edge server 302 analyzes task attributes, edge server attributes of the edge server 302, edge server attributes of other edge servers, including edge server 303, attributes of the cloud server 304, and network attributes to determine whether to offload the task to another edge server or to the cloud server.

The edge server 302 analyzes its own computing resources and pending tasks to determine if it has sufficient local computing resources to process the task. The edge server 302 determines that it has sufficient computing resources to perform the task, but its task queue would result in a delay in performing the task that exceeds a specified timeframe of 30 seconds for completing the task. Since the estimated timeframe for performing the task exceeds the specified timeframe, the system analyzes other network nodes, including the edge server 303 and the cloud server 304, to determine whether or not to offload the task to another network node.

The edge server 302 determines a latency and power required to transmit the task to the cloud server 304, process the task by the cloud server 304, and transmit the results from the cloud server 304 to the edge device 301. The edge server 302 determines that, based on the complexity of the task and the latency in transmitting task data, the cloud server 304 would not be a candidate for offloading the task.

The edge server 302 identifies a set of candidate edge servers, including the edge server 303, within a defined distance of the edge server 302. For example, the set of candidate edge servers may be located within a particular data center or within data centers in a geographical region. The edge server 302 identifies one subset of the candidate edge servers that do not have the type of AI model running on the edge server that is required to perform the task. The edge server 302 eliminates these edge servers as candidates for offloading the task. The edge server 302 identifies another subset of candidate edge servers that lack sufficient processing capacity to process the task. The edge server 302 eliminates these edge servers as candidates for offloading the task. The edge server 302 identifies a third subset of candidate edge servers that would require an amount of energy to process the task, including transmitting the task data to the candidate edge servers and AI model results from the candidate edge servers that exceeds a threshold power level. The edge server 302 eliminates these edge servers as candidates for offloading the task.

The edge server 302 determines that the edge server 303 has sufficient processing capacity to process the task, runs the type of AI model required to process the task, would consume a level of power that is less than a threshold level of power, and could complete the task within the specified timeframe. The edge server 302 analyzes task log data for the edge server 303 to determine that the edge server 303 has processing capacity, based on its pending tasks, to execute the task. For example, the edger server 302 may determine that a priority level of the task is higher than the priority level of a queued task in the edge server 303. Accordingly, offloading the task to the edge server 303 would result in the edge server 303 processing the task prior to its queued tasks.

Based on determining (a) the task meets offload criteria, (b) the edger server 303 has sufficient processing capacity to process the task within the specified timeframe, and (c) a power level required to offload the task meets a threshold: the edger server 302 offloads the task to edge server 303 (Operation 311). Offloading the task includes transmitting the task instructions and data to the edger server 303. The task data includes a set of input data to be provided to an AI model stored in the edge server 303. The input data may be transmitted as vector data. Alternatively, the input data may be transmitted as raw data, and the edge server 303 may convert the input data into vector data to input into the AI model.

The edge server 303 generates a task notification and transmits the task notification to the cloud server 304 (Operation 312). The task notification includes a task description, including a type of task, a task identifier, and a size of the task.

The cloud server 304 generates a task notification broadcast (Operation 313). The broadcast provides the data included in the task notification received from the edge server 303. The cloud server 304 transmits the task notification broadcast to edge servers in the same network as the cloud server 304, including the edge servers 302 and 303. The task notification broadcast specifies that the task was offloaded from the edge server 302 to the edge server 303. The edge servers 302 and 303 update their task log data based on the task notification broadcast (Operation 314).

The edge server 303 processes the task on the AI model stored on the edge server 303 (Operation 315). In an example embodiment where the AI model is a classification type model, the edge server converts a set of input data into an input vector, applies the input vector to the AI model, and obtains a classification result from the AI model. According to another example where the AI model is a generative model, the edge server 303 generates an input prompt to direct the model to generate content, such as text, images, software code, or other content. According to another example where the AI model is a deep-learning type model for modifying image data, the edge server 303 provides image data as input data to the model. The model generates a set of output image data, such as data that is displayed as an image with modified hues, brightness, sharpness, and other image characteristics.

The edge server 303 transmits task results to the edge device 301 (Operation 316). According to one example, the AI model is a deep learning machine learning model. The deep learning model may include speech recognition functionality. Based on inputting speech data, such as audio data, to the AI model, the AI model may generate semantic data. The semantic data may include a direct transcription of the audio data. The semantic content may include additional data such as application functions associated with the transcribed words. The edge server 303 transmits the semantic content to the edge device 301.

According to another example embodiment, the deep learning model includes image recognition functionality. Based on inputting visual data to the AI model, the AI model may generate classification data. The classification data may include a classification of image elements, such as identifying a face in the image data and/or classifying an identified face as belonging to a particular person. The edge server 303 transmits the classification data to the edge device 301.

The edge device 301 implements the task results in the application running on the edge device 301 (Operation 317). A translation application may implement semantic content by generating an audio output from the edge device 301 that corresponds to the translated words from the audio data. A digital personal assistant may implement the semantic content by opening, closing, creating, deleting, and modifying files, documents, and calendar entries. A photo editing application may implement classification data by generating a recommendation to tag a face in a photo displayed on the edge device 301. A secure digital wallet application may implement classification data by granting access to a secure digital wallet based on determining an individual identified in the classification data has authority to access the secure digital wallet.

Based on the AI model completing the task, the edge server 303 generates a task completion notification (Operation 318). The edge server 303 transmits the task completion notification to the cloud server 304. The cloud server 304 generates a task notification broadcast (Operation 319). The cloud server 304 transmits the task notification broadcast to edge servers in the same network as the cloud server 304, including the edge servers 302 and 303. The task notification broadcast specifies that the task was completed. The edge servers 302 and 303 update their task log data based on the task notification broadcast (Operation 320).

FIG. 3B illustrates a set of processes according to an alternative embodiment. While FIG. 3A illustrates an example embodiment where the edge server 303 transmits AI model output results to the edge device 301, FIG. 3B illustrates an embodiment wherein the edge server 303 transmits the AI model output results to the edge server 302. In other words, FIG. 3A describes an embodiment where a device transmits a request to one edge server to perform a task by an AI model stored on the edge server. The device receives task results from a different edge server based on the first edge server offloading the task to the second edge server. In contrast, FIG. 3B describes an embodiment where edge server 302 offloads a task to edge server 303 (Operations 305-315), and the device receives the results from the edge server 302. Instead of transmitting task results directly to the edge device 301, edge server 303 transmits the task results to the edge server 302 (Operation 321).

The edge server 302 transmits the task results received from edge server 303 to the edge device 301 (Operation 322). Similar to FIG. 3A, the edge server 302 transmits a task completion notification to the cloud server 304 (Operation 323). The cloud server 304 generates a task notification broadcast to edge servers in the same network as the cloud server 304 (Operation 324). The edge servers 302 and 303 update their task log data based on the task notification broadcast (Operation 325).

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Generative AI Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 114, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 124, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 119, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 7. Hardward Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

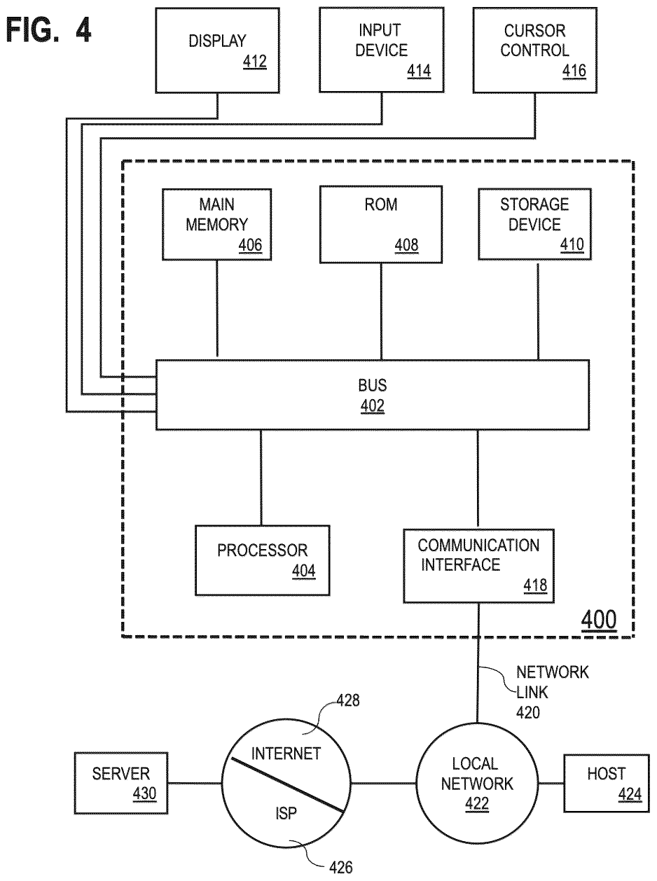

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
receiving a first request at first edge node of a first network to execute a first task by a first artificial intelligence (AI) model implemented in the first edge node;
determining, by the first edge node, whether to execute the first task or offload the first task to another edge node in the first network at least by:
identifying a set of local attributes of the first edge node;
identifying a set of remote attributes of a set of one or more remote edge nodes in the first network, the set of one or more remote edge nodes including at least a second edge node; and
based on the set of local attributes of the first edge node and the set of remote attributes of the set of one or more remote edge nodes, determining to offload the first task to the second edge node in the first network; and
transmitting the first request to the second edge node to execute the first task by a second AI model implemented in the second edge node.

2. The one or more non-transitory computer readable media of claim 1, wherein the set of local attributes and the set of remote node attributes include:
a complexity of the first task;
first device resources of the first edge node and second device resources of the second edge node;
a first device resource utilization value of the first edge node and a second device resource utilization value of the second edge node; and
network conditions in the first network.

3. The one or more non-transitory computer readable media of claim 1, wherein the set of local attributes and the set of remote node attributes include at least one of:
a task priority associated with the first request; and
energy consumption associated with executing the first task.

4. The one or more non-transitory computer readable media of claim 1, wherein determining, by the first edge node, whether to execute the first task or offload the first task to another edge node in the first network, comprises:
determining whether the first edge node has sufficient local computing resources execute the first task within a specified timeframe;
determining whether the second edge node has sufficient remote computing resources execute the task within the specified timeframe; and
determining a latency associated with offloading the first task to the second edge node.

5. The one or more non-transitory computer readable media of claim 1, wherein the operations further comprise:
receiving, by the first edge node, a set of notifications specifying a set of tasks assigned to the set of one or more remote edge nodes in the first network, wherein the set of notifications includes a subset of notifications specifying a subset of tasks assigned to the second edge node; and
based on receiving the set of notifications, updating, by the first edge node, a record of the set of tasks assigned to the set of one or more remote edge nodes,
wherein determining, by the first edge node, whether to execute the first task or offload the first task to another edge node in the first network comprises analyzing the record of the set of tasks assigned to the set of one or more remote edge nodes to determine workloads of the set of one or more remote edge nodes.

6. The one or more non-transitory computer readable media of claim 1, wherein determining to offload the first task to the second edge node in the first network comprises:
determining the first task is associated with a first type of AI model;
identifying the second edge node and a third edge node in the first network;
based on determining the third edge node implements a third AI model of a second type, refraining from selecting the third edge node for offloading the first task; and
based at least on determining the second AI model implemented on the second edge node is of the first type, selecting the second edge node for offloading the first task.

7. The one or more non-transitory computer readable media of claim 1, wherein the operations further comprise:
receiving a second request at the first edge node to execute a second task by the first AI model implemented in the first edge node;
based on the set of local attributes and the set of remote attributes, determining, at a first time, to execute the second task by the first AI model implemented in the first edge node;
receiving, by the first edge node, at a second time subsequent to the first time, a notification specifying a set of tasks assigned to the set of one or more remote edge nodes in the first network, wherein the notification specifies a subset of tasks assigned a third edge node;
based on receiving the notification, updating, by the first edge node, a record of the set of tasks assigned to the third edge node, wherein updating the record includes generating an updated set of remote attributes; and
based on the set of local attributes and the updated set of remote attributes, determining, by the first edge node, to offload the second task to the third edge node.

8. The one or more non-transitory computer readable media of claim 1, wherein the first edge node is part of a first network cell including a first central server, the first edge node, and a first set of edge nodes,
wherein the second edge node is part of a second network cell including a second central server, the second edge node, and a second set of edge nodes,
wherein the set of remote attributes includes a first set of remote attributes corresponding to the first set of edge nodes and a second set of remote attributes corresponding to the second set of edge nodes, and
wherein the operations further comprise:
based at least on the first set of remote attributes, determining, by the first edge node, to refrain from offloading the first task to any edge node among the first set of edge nodes; and
based on determining to refrain from offloading the first task to any edge node among the first set of edge nodes, determining, by the first edge node, whether to offload the first task to any edge node in the second network cell.

9. The one or more non-transitory computer readable media of claim 1, wherein the first request is received from a requesting device, and
wherein the operations further comprise:
generating, by the second AI model, a set of results corresponding to the first task; and
transmitting the set of results by the second edge node to the requesting device.

10. The one or more non-transitory computer readable media of claim 1, wherein the first request is received from a requesting device, and
wherein the operations further comprise:
generating, by the second AI model, a set of results corresponding to the first task;
transmitting the set of results by the second edge node to the first edge node; and
transmitting the set of results by the first edge node to the requesting device.

11. A method comprising:
receiving a first request at first edge node of a first network to execute a first task by a first artificial intelligence (AI) model implemented in the first edge node;
determining, by the first edge node, whether to execute the first task or offload the first task to another edge node in the first network at least by:
identifying a set of local attributes of the first edge node;
identifying a set of remote attributes of a set of one or more remote edge nodes in the first network, the set of one or more remote edge nodes including at least a second edge node; and
based on the set of local attributes of the first edge node and the set of remote attributes of the set of one or more remote edge nodes, determining to offload the first task to the second edge node in the first network; and
transmitting the first request to the second edge node to execute the first task by a second AI model implemented in the second edge node,
wherein the method is performed by at least one device including a hardware processor.

12. The method of claim 11, wherein the set of local attributes and the set of remote node attributes include:
a complexity of the first task;
first device resources of the first edge node and second device resources of the second edge node;
a first device resource utilization value of the first edge node and a second device resource utilization value of the second edge node; and
network conditions in the first network.

13. The method of claim 11, wherein the set of local attributes and the set of remote node attributes include at least one of:
a task priority associated with the first request; and
energy consumption associated with executing the first task.

14. The method of claim 11, wherein determining, by the first edge node, whether to execute the first task or offload the first task to another edge node in the first network, comprises:
determining whether the first edge node has sufficient local computing resources execute the first task within a specified timeframe;
determining whether the second edge node has sufficient remote computing resources execute the task within the specified timeframe; and
determining a latency associated with offloading the first task to the second edge node.

15. The method claim 11, further comprising:
receiving, by the first edge node, a set of notifications specifying a set of tasks assigned to the set of one or more remote edge nodes in the first network, wherein the set of notifications includes a subset of notifications specifying a subset of tasks assigned to the second edge node; and
based on receiving the set of notifications, updating, by the first edge node, a record of the set of tasks assigned to the set of one or more remote edge nodes,
wherein determining, by the first edge node, whether to execute the first task or offload the first task to another edge node in the first network comprises analyzing the record of the set of tasks assigned to the set of one or more remote edge nodes to determine workloads of the set of one or more remote edge nodes.

16. The method of claim 11, wherein determining to offload the first task to the second edge node in the first network comprises:
determining the first task is associated with a first type of AI model;
identifying the second edge node and a third edge node in the first network;
based on determining the third edge node implements a third AI model of a second type, refraining from selecting the third edge node for offloading the first task; and
based at least on determining the second AI model implemented on the second edge node is of the first type, selecting the second edge node for offloading the first task.

17. The method of claim 11, further comprising:
receiving a second request at the first edge node to execute a second task by the first AI model implemented in the first edge node;
based on the set of local attributes and the set of remote attributes, determining, at a first time, to execute the second task by the first AI model implemented in the first edge node;
receiving, by the first edge node, at a second time subsequent to the first time, a notification specifying a set of tasks assigned to the set of one or more remote edge nodes in the first network, wherein the notification specifies a subset of tasks assigned a third edge node;
based on receiving the notification, updating, by the first edge node, a record of the set of tasks assigned to the third edge node, wherein updating the record includes generating an updated set of remote attributes; and
based on the set of local attributes and the updated set of remote attributes, determining, by the first edge node, to offload the second task to the third edge node.

18. The method of claim 11, wherein the first edge node is part of a first network cell including a first central server, the first edge node, and a first set of edge nodes,
wherein the second edge node is part of a second network cell including a second central server, the second edge node, and a second set of edge nodes,
wherein the set of remote attributes includes a first set of remote attributes corresponding to the first set of edge nodes and a second set of remote attributes corresponding to the second set of edge nodes, and
wherein the method further comprises:
based at least on the first set of remote attributes, determining, by the first edge node, to refrain from offloading the first task to any edge node among the first set of edge nodes; and
based on determining to refrain from offloading the first task to any edge node among the first set of edge nodes, determining, by the first edge node, whether to offload the first task to any edge node in the second network cell.

19. The method of claim 11, wherein the first request is received from a requesting device, and
wherein the method further comprises:
generating, by the second AI model, a set of results corresponding to the first task; and
transmitting the set of results by the second edge node to the requesting device.

20. A system comprising:
at least one device including a hardware processor;
the system being configured to perform operations comprising:
receiving a first request at first edge node of a first network to execute a first task by a first artificial intelligence (AI) model implemented in the first edge node;
determining, by the first edge node, whether to execute the first task or offload the first task to another edge node in the first network at least by:
identifying a set of local attributes of the first edge node;
identifying a set of remote attributes of a set of one or more remote edge nodes in the first network, the set of one or more remote edge nodes including at least a second edge node; and
based on the set of local attributes of the first edge node and the set of remote attributes of the set of one or more remote edge nodes, determining to offload the first task to the second edge node in the first network; and
transmitting the first request to the second edge node to execute the first task by a second AI model implemented in the second edge node.
